(19) United States
(12) Patent Application Publication
(10) Pub. No.: US 2003/0162454 A1
(43) Pub. Date: Aug. 28, 2003

(54) Structure of synthetic leather

(76) Inventor: Kuo-Ho Kuo, Taipei (TW)

Correspondence Address: BRUCE H. TROXELL, SUITE 1404, 5205 LEESBURG PIKE, FALLS CHURCH, VA, 22041, US

(21) Appl. No.: 10/397,190

(22) Filed: Mar. 27, 2003

Related U.S. Application Data
(63) Continuation-in-part of application No. 09/222,887, filed on Dec. 30, 1998, now abandoned.

(51) Int. Cl. B32B 27/12; B23B 5/02

(52) U.S. Cl. 442/183; 428/904; 442/328; 442/394; 442/286

(57) ABSTRACT

Synthetic leather includes a piece of backing cloth with all-direction stretchability located at one side of the synthetic leather, a surface skin located at another side of the synthetic leather, and an intermediate layer fixed between the backing cloth and the surface skin for providing thickness of the synthetic leather. The elongation property value of the backing cloth is more than 200% in all-direction. Thereby the synthetic leather of the present invention can concurrently have characteristics of high thickness, high softness and a fine-break surface.

### BACKGROUND OF THE INVENTION

1. Field of the Invention

The present invention relates to a structure of a synthetic leather, and more particularly to an unproved structure of a synthetic leather having characteristics of high thickness, high softness and a fine-break surface. This is a continue-in-part (CIP) application of U.S. patent application Ser. No. 09/222,887.

2. Description of the Prior Art

In the early development of human history, the leather products of shoes or clothes were manufactured by genuine leathers of hunted animals. Those leather products were by-product of food. Because of the limitation of natural sources, the supply of genuine leathers was unstable and limited. Also, the cost of genuine leathers was expensive. Until the development of petrochemical industry, the technology of producing synthetic leathers is gradually mature. The supply of synthetic leathers is stable, and the cost of synthetic leathers is cheaper. Furthermore, a variety of synthetic leathers can be produced according to the requests of different products.

In general, a synthetic leather has two basic elements. One is an upper structure located at one end of the synthetic leather for providing thickness and a genuine leather-like appearance and touch. Another is a piece of backing cloth located at another end or in the middle of the synthetic leather for providing physical properties. The upper structure and the backing cloth are fixed together to form a multilayer synthetic leather. In order to produce a synthetic leather with an improved quality, the thickness, softness, and surface break (crumple from bending) of synthetic leathers are important characteristics for new developed synthetic leathers.

Generally, the synthetic leather products with high thickness and high softness have wide commercial use as a substitute for genuine leathers in the production of various articles such as shoes, hiking boots, wearing apparel, baseball gloves, and accessories. However, in the conventional products, synthetic leathers cannot concurrently have the characteristics of high thickness, high softness and a fire-break surface. Now referring to FIG. 1, a cross-section view of a conventional synthetic leather with a poor-break surface, a synthetic leather has a piece of backing cloth 1 and an upper structure 2. When the surface of synthetic leather is bended concave, the poor break (or rough break) is formed by compressing in the top surface of the upper structure 2. The degree of break roughness will increase with the increasing thickness. In the prior art, the hardness of the upper structure 2 is increased for alleviating the break roughness, which will effect the touch and feeling property of the leather. Therefore, the conventional synthetic leather products cannot concurrently have the characteristics of high thickness, high softness and a fine-break surface.

### SUMMARY OF THE INVENTION

It is an object of the present invention to provide an improved structure of a synthetic leather having characteristics of thickness, softness and a fine-break surface.

It is another object of the present invention to provide an improved structure of a synthetic leather by using a piece of all-direction stretchable backing cloth to avoid a poor-break surface.

It is another object of the present invention to provide an improved structure of a synthetic leather by using a piece of all-direction stretchable backing cloth to improve the quality of high-thickness synthetic leather products without the problem that high-thickness synthetic leather products cannot have the characteristic of fine-break surface.

It is a further object of the present invention to provide an improved structure of a synthetic leather by using a piece of all-direction stretchable backing cloth to improve the quality of high-softness synthetic leather products without the problem that high-softness synthetic leather products cannot have the characteristic of fine-break surface.

### BRIEF DESCRIPTION OF THE DRAWINGS

The invention, as well as its many advantages, may be further understood by the following detailed description and drawings in which:

FIG. 1 is a cross-section view of a conventional synthetic leather with a poor-break surface.

FIG. 2 is a cross-section view of a synthetic leather according to the embodiment of the present invention.

FIG. 3 is a cross-section view of a synthetic leather with a fine-break surface according to the embodiment of the present invention.

FIG. 4 is a schematic diagram showing a preferred example of Step B of a manufacturing method for manufacturing the synthetic leather of the present invention (Step B: Applying adhesive 54 onto the surface skin layer 20).

FIG. 5 is a schematic diagram showing a preferred example of Step C of a manufacturing method for manufacturing the synthetic leather of the present invention (Step C: Adhering the surface skin layer 20 to the intermediate layer 30).

FIG. 6 is a schematic diagram showing a preferred example of Step D of a manufacturing method for manufacturing the synthetic leather of the present invention (Step D: Adhering the backing cloth layer 10 to the half-finished synthetic leather 70).

### DETAILED DESCRIPTION OF THE PREFERRED EMBODIMENT

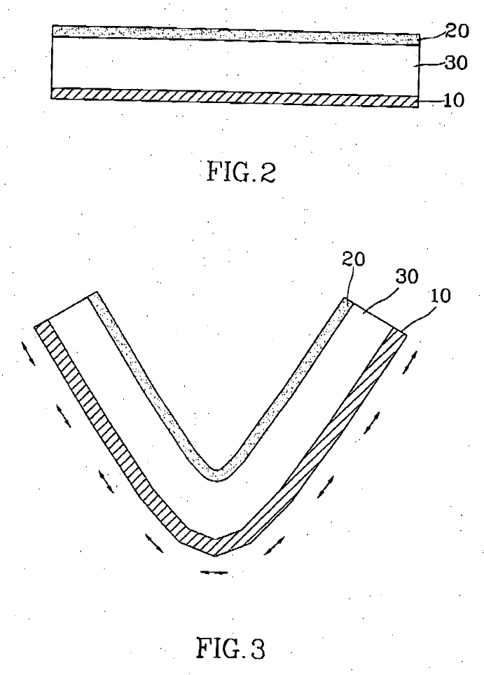

The drawing figures illustrate a synthetic leather with a three-layer structure as a preferred embodiment of the present invention .Referring now to FIG. 2, a synthetic leather according to this invention includes a surface skin 20, an intermediate layer 30 and a backing cloth 10. According to the object of producing a high-thickness synthetic leather, the total thickness of the surface 20, the intermediate layer 30 and the backing cloth 10 is more than 1.5 mm.

The surface skin 20 is located at one side of the synthetic leather. The surface skin 20 is synthesized by materials, such as polyvinyl chloride (PVC), polyurethane (PU), non-woven cloth, etc., for providing a genuine leather-like touch and appearance. In this embodiment, a PU synthetic leather, P.U. Brazil Leather, is used to be the surface skin 20. The P.U. Brazil Leather itself is a finished synthetic leather with a piece of backing cloth.

The intermediate layer 30 fixed under the surface skin 20 provides the thickness and softness of the synthetic leather of this invention. The materials selection for the intermediate layer 30 is according to the required thickness and softness of applied products. In general, synthetic leather, non-woven cloth, synthetic fiber, synthetic rubber, etc. are possible materials for the intermediate layer 30. In this embodiment, a synthetic rubber with a thickness of about 1.5 mm is used to be the intermediate layer 30.

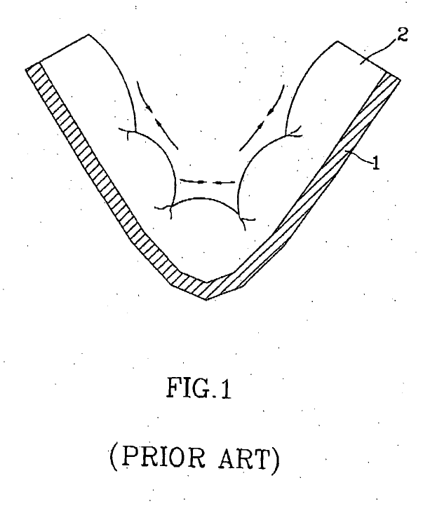

The key of this invention is the backing cloth 10 fixed under the intermediate layer 30. Conventionally, a backing cloth is set for providing physical strength to the upper structure (including the surface skin and the intermediate layer). However, the inventor of the present invention found that the major reason resulting the synthetic leather surface having a poor-break is due to the equivalent length of the backing cloth and the upper structure. When the surface of the synthetic leather is bended concave, the backing cloth in a conventional synthetic leather cannot be stretched easily because of its poor stretchability. Therefore, the bending force will concentrate to compress in the surface skin of the conventional synthetic leather to form the poor-break surface as shown in FIG. 1. Furthermore, a bent synthetic leather with a higher thickness has a higher degree of surface break roughness due to a stronger compressing force. In the prior art, the backing cloth of a synthetic leather usually is a piece of non-stretchable cloth which will result in poor-break surface at all direction on the synthetic leather surface. Or the backing cloth of a conventional synthetic leather could be a piece of one-direction stretchable cloth which will result in poor-break surface in all directions except the stretchable direction on the synthetic leather surface.

According to the above description, the present invention uses a piece of cloth with “all-direction stretchability” as the backing cloth of a synthetic leather, which is the key point of this invention. In this embodiment, a two-direction stretchable cloth is selected to be the backing cloth 10. The two-direction stretchable cloth has stretchability at two directions, X and Y directions, which are perpendicular to each other. Because any force applied to the synthetic leather layer can be divided into two components along X and Y directions, the direction along the applied force on the backing cloth is also stretchable. Therefore, the two-direction stretchable cloth is a cloth with “all-direction stretchability”.

Referring to FIG. 3, when the synthetic leather surface is bent concave, the bending force can be applied to the backing cloth 10 easily and “stretches out” the backing cloth 10, because the backing cloth 10 in this invention has a better tensile strength at all directions. Thereby the bending force will not “compress in” the surface skin 20. Therefore, the surface break of the synthetic leather is fine, and the appearance and touch of the synthetic leather are improved efficiently. Even though the thickness and softness of the upper structure (including the surface skin 20 and the intermediate layer 30) is increased, the problem of poor-break surface can be avoided by using a piece of all-direction stretchable cloth for manufacturing high quality products.

As described above, this invention provided an improved structure of synthetic leather by using a piece of all-direction stretchable cloth as the backing cloth. Thereby this invention can avoid the disadvantage of the synthetic leather poor-break surface and provide for manufacturing synthetic leather products concurrently having characteristics of high thickness, high softness and fine-break surface. Although the preferred embodiment provides a three-layer structure, any multilayer structures with the all-direction stretchable backing cloth disclosed by the present invention are covered by this invention, such as a double-layer structure including one-layer surface structure and a piece of all-direction stretchable backing cloth, or at least three-layer structure including an at least two-layer upper structure and a piece of all-direction stretchable backing cloth.

In the present invention, a preferred embodiment of surface skin 20 of the synthetic leather is the P.U. Brazil leather. The physical properties of a typical P.U. Brazil Leather are listed in the following table:

P.U. Brazil Leather (surface skin 20)

| | | |
|---|---|---|
| TEARING STRENGTH (KG) | MD | 3.0 |
| | CD | 1.5 |
| TENSILE STRENGTH (KG) | MD | 15 |
| | CD | 15 |
| ELONGATION (%) | MD | 15 |
| | CD | 30 |
| BONDING STRENGTH (KG) | MD | 0.8 |
| | CD | 0.8 |
| BURSTING (KG/M²) | | 24 |

| | |
|---|---|
| Anti-Hydrolysis | PASS |
| 10% NaOH, 25° C. × 24 hrs | |

Where the term “MD” means “machine direction” which refers to the proceeding direction of material (e.g., P.U. Brazil Leather) when being handled by a manufacturing machine. The term “CD” means “cross direction” which is perpendicular to the MD.

A preferred embodiment of intermediate layer 30 of the synthetic leather is the synthetic rubber. The physical properties of a typical synthetic rubber made by styrene butadiene copolymer are listed in the following table:

Synthetic Rubber (intermediate layer 30)

| | |
|---|---|
| Hardness (°) | 10-12 |
| Elongation (%) | 250 ↑ |
| Tensile Strength (Kg/cm²) | 5 ↑ |
| Tear Strength (Kg/cm) | 1.5 ↑ |
| Compression Set (%) | 25 ↓ |
| Density (g/cm³) | 0.2+/−0.02 |
| Waler Absorption (%) | 3 ↓ |

A preferred embodiment of backing cloth 10 of the synthetic leather is the LYCRA. The physical properties of a typical LYCRA of NYLON 40D X SPANDEX 40D and SPANDEX (LYCRA) content 20 0/0 with weight 150 GRAM/44 inch are listed in the following table:

LYCRA (backing cloth 10)

| | | |
|---|---|---|
| TEARING STRENGTH (KG) | MD | 2.8 |
| | CD | 2.6 |
| TENSILE STRENGTH (KG/3 CM) | MD | 5.21 |
| | CD | — |
| ELONGATION (%) | MD | 340 |
| | CD | — |
| AVERAGE WEIGTH (G/M2) | | 148 |

It is noted that, the value of “Elongation (%)” of LYCRA (i.e., the backing cloth 10 of the present invention) in the CD direction (i.e., cross direction) is beyond the available testing range of the testing equipment. That is, the Elongation property of LYCRA in CD direction must be much larger than 340%. It is suggested that the elongation property value of LYCRA in CD direction should be more than 600%.

It can be seen from the above tables, that the elongation property value of the backing cloth 10 must be much larger than which of the surface skin 20, says about twenty times the value Such kind of arrangement can make sure the backing cloth 10 having sufficient all-directional stretchability to prevent poor-break surface of the surface skin 20 when the synthetic leather is subjected to a bending force. It is suggested that the backing cloth 10 of the present invention must has an elongation property value of no less than 200% (or ten times the value of surface skin 20) in both MD and CD directions to retain desirable result of wrinkle prevention.

It is noted that, since the backing cloth 10 of the present invention has relative large elongation property value. Therefore, it cannot be adhered to the intermediate layer 30 by using ordinary conventional method. It is because that, conventional way to adhere two layers of cloth-like material usually applies several rollers to “pull out” the cloth-like material before starting to adhere one to the other. Since the elongation property value of the backing cloth 10 of the present invention is relatively large (that is, the backing cloth 10 is all-direction stretchable), therefore the backing cloth 10 will definitely be lengthened before being attached/adhered to another material (intermediate layer 30, for example). Once such pulling force disappeared, the backing cloth 10 tends to shorten and the appearance of the synthetic leather product will become deformed and ugly. To overcome the deficiency of the conventional manufacturing method of mutilayer synthetic leather, the present invention discloses a novel manufacturing method to fabricating the laminated structure of synthetic leather.

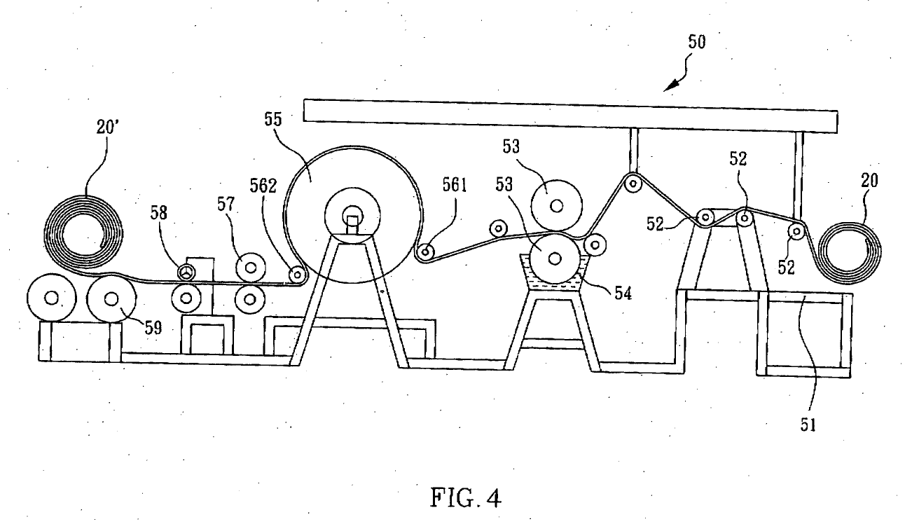

Please refer to FIGS. 4, 5 and 6, in which a preferred example of manufacturing method for manufacturing the synthetic leather of the present invention is illustrated. The manufacturing method comprises the following steps:

(A) Providing a plurality of manufacturing machines 50, 50a and 50b. Each of the manufacturing machines 50, 50a and 50b comprises respectively a support 51, 51a, 51b for supporting an object to be handled, a plurality of guiding rollers 52, 52a, 52b, 57, 57a, 57b, 58, 58a, 58b for pulling and guiding the object to go along a predetermined direction (i.e., so called “machine direction”), a set of glue applying rollers 53, 53a, 53b to apply adhesive 54 onto the object, a set of roller wheel 55, 55a, 55b and jostling rollers 561, 561a, 561b, 562, 562a, 562b for providing pressing force to the object, and a set of rollers 59, 59a, 59b for rolling up the handled object to be a roll.

(B) Applying adhesive 54 onto the surface skin layer 20. Please refer to FIG. 4. In this step, firstly the guiding rollers 52 pull out the surface skin layer 20 and guide it to proceed along the machine direction. Then, the glue. applying rollers 53 apply adhesive 54 onto one surface of the surface skin layer 20. The roller wheel 55 and jostling rollers 561 then provides desired heat and pressure to dry the adhesive of the surface skin layer 20. After that, the rollers 59 help the surface skin layer 20 to form a roll of glued surface skin layer 20′ for next step use.

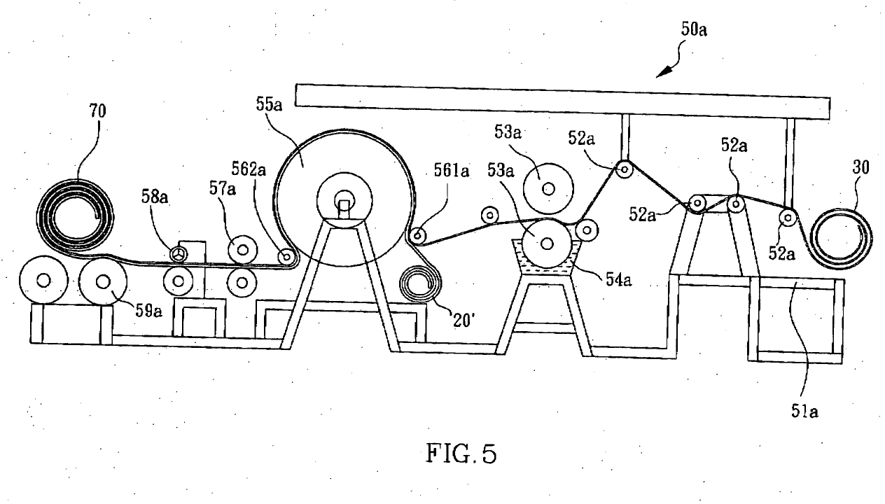

(C) Adhering the surface skin layer 20 to the intermediate layer 30. Please refer to FIG. 5. The glued surface ski layer 20′ is positioned under the set of roller wheel 55a and jostling rollers 561a, while the intermediate layer 30 is positioned on the support 51a. The guiding rollers 52a pull out the intermediate layer 30 and the glue applying rollers 53a apply adhesive 54a onto one surface of the intermediate layer 30. The glued surface skin layer 20′ and the intermediate layer 30 are then compressed and heated by the roller wheel 55a and jostling rollers 561a to make them adhered to each other. After that, the adhered surface skin layer 20′ and the intermediate layer 30 become a half-finished synthetic leather 70 and is rolled by the rollers 59a for next step use.

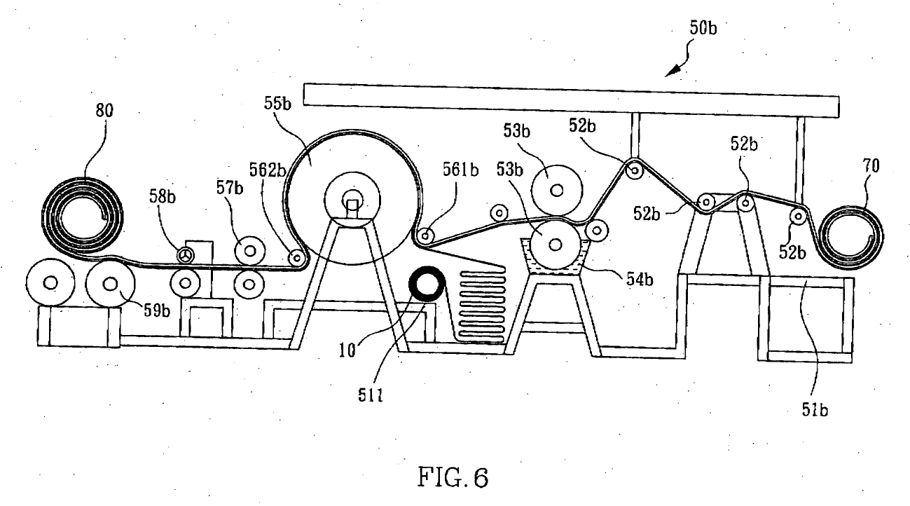

(D) Adhering the backing cloth layer 10 to the half-finished synthetic leather 70. Please refer to FIG. 6. The half-finished synthetic leather 70 is positioned on the support 51b. The guiding rollers 52b pull out the half-finished synthetic leather 70 and the glue applying rollers 53b apply adhesive 54b onto the surface (which is to be adhered with the backing cloth layer 10) of the half-finished synthetic leather 70. In the mean time, the backing cloth layer 10 is positioned under the set of roller wheel 55b and jostling rollers 561b. Then, making the backing cloth layer 10 to be in a loosen condition by a loosing means before the backing cloth layer 10 being adhered to the glued surface of the half-finished synthetic leather 70. Here so called “loosen condition” is a very important key point of the manufacturing method of the present invention. As shown in FIG. 6, the loosing means of the present invention is to firstly position the backing cloth layer 10 under the pressing roller wheel 55b, and then extend and loose the backing cloth layer 10 a sufficient length (let them loosely lying on the ground) before further extend the backing cloth layer 10 upward to make contact with the half-finished synthetic leather 70. By such kind of “loosen” arrangement, the backing cloth layer 10 of the present invention is subjected to no pulling force along the machine direction (only suffers the weight of itself) before attach to the half-finished synthetic leather 70. Therefore, the backing cloth layer 10 will be able to retain its original length and will not be elongated by the guiding rollers 52b. The glued half-finished synthetic leather 70 and the backing cloth layer 10 are then compressed and heated by the roller wheel 55b and jostling rollers 561b to make them adhered to each other so as to become a completed synthetic leather product 80. After that, the synthetic leather product 80 and is rolled by the rollers 59b for storage, shipment or sale.

It may thus be seen that the objects of the present invention set forth herein, as well as those made apparent from the foregoing description, are efficiently attained. While the preferred embodiment of the invention has been set forth for purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A laminated structure of synthetic leather made by a manufacturing method, said laminated structure of synthetic leather comprising:
a surface skin layer of synthetic leather;
a backing cloth layer comprising a cloth that is stretchable in two perpendicular directions, said backing cloth having an elongation property of more than 200% in both of said two directions; and,
an intermediate layer affixed to and located between the surface skin layer and backing cloth layer, wherein a thickness of the intermediate layer is greater than thickness of the surface skin layer and the backing cloth layer;
said manufacturing method comprising at least the steps of:
providing a half-finished synthetic leather, said half-finished synthetic leather including at least said intermediate layer;
using a plurality of guiding rollers to continuously pull out the half-finished synthetic leather along a machine direction;
applying glue on a surface of the intermediate layer which is to be adhered with the backing cloth layer;
making the backing cloth layer to be in a loosen condition by a loosing means before the backing cloth layer being adhered to the glued surface of the intermediate layer of the half-finished synthetic leather;
using a set of pressing roller wheel and jostling rollers to pull the half-finished synthetic leather together with the backing cloth layer and providing compressing force to let them adhered to each other;
wherein, just before the half-finished synthetic leather contacts the backing cloth layer, the half-finished synthetic leather is subjected to a pulling force along the machine direction, while the backing cloth layer is in said loosen condition without any pulling force along the machine direction being applied thereon.

2. The structure as recited in claim 1, wherein said surface skin layer comprises a synthetic leather having a second backing cloth.

3. The structure as recited in claim 1, wherein said surface skin layer, said intermediate layer and said backing cloth layer have a total thickness of more than 1.5 mm.

4. The structure as recited in claim 1, wherein said intermediate layer has a thickness of about 1.5 mm.

5. The structure as recited in claim 1, wherein the half-finished synthetic leather includes the intermediate layer and the surface skin layer adhered to each other.

6. The structure as recited in claim 1, wherein said loosing means is to firstly position the backing cloth layer under said pressing roller wheel, and then extend and loose the backing cloth layer a sufficient length before further extend the backing cloth layer upward to make contact with the half-finished synthetic leather.

7. The structure as recited in claim 1, wherein, by bending the laminated structure of synthetic leather, the surface skin layer is concave thereby generating a bending force within the synthetic leather whereby the bending force stretches the backing cloth layer without causing wrinkles in the surface skin layer of synthetic leather.
